(19) United States
(12) Patent Application Publication
(10) Pub. No.: US 2008/0033643 A1
(43) Pub. Date: Feb. 7, 2008

(54) Route retrieval apparatus

(75) Inventor: Yasuhiro Shimizu, Tokoname-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/826,849

(22) Filed: Jul. 19, 2007

(30) Foreign Application Priority Data
Aug. 2, 2006 (JP) 2006-211325

(51) Int. Cl. G01C 21/30

(52) U.S. Cl. 701/209

(57) ABSTRACT

It is determined whether a retrieved route includes a predetermined route section. In the predetermined route section, a subject vehicle is guided to enter a certain road having multiple lanes via a lane on one side of the certain road. The subject vehicle is then guided to change lanes to the lane on the opposite side to exit from the certain road to another road. When the predetermined route section is included, a travel estimation cost for the travel in the predetermined route section is computed based on the travel distance and the number of lanes with respect to the certain road. Then, an estimation cost for the retrieved route is computed by considering the travel estimation cost for the travel on the predetermined route section. Thus, the difficulty in changing lanes in the multiple lane road can be considered when an optimal route is selected.

### CROSS REFERENCE TO RELATED APPLICATION

This application is based on and incorporates herein by reference Japanese Patent Application No. 2006-211325 filed on Aug. 2, 2006.

### FIELD OF THE INVENTION

The present invention relates to a route retrieval apparatus which searches for a route from a departure point to a destination.

### BACKGROUND OF THE INVENTION

A navigation apparatus provided in a vehicle generally includes a route retrieval apparatus which searches for a route from a departure point to a destination. The vehicle may deviate from a guide route. In this case, the route retrieval apparatus re-searches for a new guide route for reaching to the destination from the point where it becomes clear that the vehicle has deviated from the guide route.

The vehicle is running when the navigation apparatus re-searches for the guide route. Therefore, during a time period from when the route retrieval is started to when ended, the vehicle position may change. When route guide is set up immediately after retrieving the guide route, the vehicle may have arrived just before the intersection which the vehicle should carry out right or left turn. In such a case, it becomes difficult for the driver of the vehicle to drive the vehicle according to the guide route.

For this reason, Patent document 1 discloses a navigation apparatus prevented from setting the route which carries out the right or left turn required immediately after the start of route guide. For instance, a guide route is set up to preferentially select a route which allows the vehicle to able to go along a running road the vehicle is currently running. A minimum distance the vehicle needs to go along the running road is determined depending on the number of lanes of the running road. That is, when the number of lanes is large, the minimum distance is lengthened so that the running road may be certainly included in the guide route as long as possible. On the contrary, when the number of lanes is small, the minimum distance is shortened. It is because the lane change takes a longer time as the number of lanes increases.

As a result, when there are many lanes, sufficient distance for the lane change can be secured before reaching the point where the vehicle should carry out the right or left turn. When there are few lanes, the guide route can be prevented as much as possible from taking a useless long route to the destination.
Patent document 1: JP-2004-271375 A (U.S. Pat. No. 7,194,355 B2)

As mentioned above, the navigation apparatus in Patent document 1 takes it into consideration that route guide is started while the vehicle is running. When retrieving a guide route, a minimum distance the vehicle should go along the running road is thus determined depending on the number of lanes of the running road. However, in the navigation apparatus in Patent document 1, the route retrieval is performed about other roads other than the running road, without taking the number of lanes into consideration.

There may be a case where a vehicle exits from an expressway and enters or joins a certain road at a junction point. When the number of lanes of the certain road is small, the vehicle can comparatively easily perform right or left turn also at the intersection which is in the short distance from the junction point. On the other hand, a longer distance up to the intersection for the right or left turn may be required when the number of lanes is larger. In particular, when the vehicle needs to perform the right or left turn by changing lanes from the joined lane to the opposite lane of the certain road, several lane changes may be necessary.

### SUMMARY OF THE INVENTION

The present invention is made in view of such a point. It is an object of the present invention to provide a route retrieval apparatus which can retrieve a more proper route. In particular, it relates to a route that needs lane change in a multiple lane road. An estimation cost is given to meet with difficulty when running such a route.

To achieve the above object, according to an example of the present invention, a route retrieval apparatus is provided as follows. A map data storage device is included for storing road map data, in which a road is indicated by links and nodes, and a number of lanes of each link. A routing device is included for retrieving a route having a minimal estimation cost from a departure point to a destination based on links and nodes of the route by using the stored road map data. The routing device comprises a predetermined traverse determination unit and a predetermined cost computing unit. The predetermined route section determination unit determines a predetermined route section included in the retrieved route, wherein the vehicle is guided to enter one side of the predetermined route section and exit from a side opposite to the one side after running for a predetermined travel distance. The predetermined cost computing unit computes a predetermined estimation cost, which is larger as the predetermined travel distance is shorter than a reference travel distance, the reference travel distance being defined based on a number of lanes included in the predetermined route section. Here, the routing device retrieves the route having the minimal estimation cost while considering the computed predetermined estimation cost.

As another example of the present invention, a method is provided for retrieving a route for a vehicle. The method comprises the steps of: retrieving a route from a departure point to a destination based on links and nodes of the route by using road map data, in which a road is indicated by links and nodes; determining a predetermined route section included in the retrieved route, wherein the vehicle is guided to enter one side of the predetermined route section and exit from a side opposite to the one side after running for a predetermined travel distance; and computing a predetermined estimation cost, which is larger as the predetermined travel distance is shorter than a reference travel distance, the reference travel distance being defined based on a number of lanes included in the predetermined route section, wherein the route having a minimal estimation cost is retrieved with the computed predetermined estimation cost considered.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram showing a configuration of an in-vehicle navigation apparatus according to an embodiment;

FIG. 2 is a flow chart diagram illustrating a guide route retrieval process and a route guide process;

FIG. 3 is a flow chart diagram illustrating details of the guide route retrieval process;

FIG. 4 is a diagram for explaining an example for computing an estimation cost;

FIG. 5A is a diagram showing a relation between the number of lanes of a subject road and reference travel distances; and

FIG. 5B is a diagram showing a relation between the number of lanes of the subject road and cost coefficients.

### DETAILED DESCRIPTION OF THE PREFERRED EMBODIMENTS

In an embodiment of the present invention, a route retrieval apparatus is adapted to or assembled into an in-vehicle navigation apparatus provided in a subject vehicle.

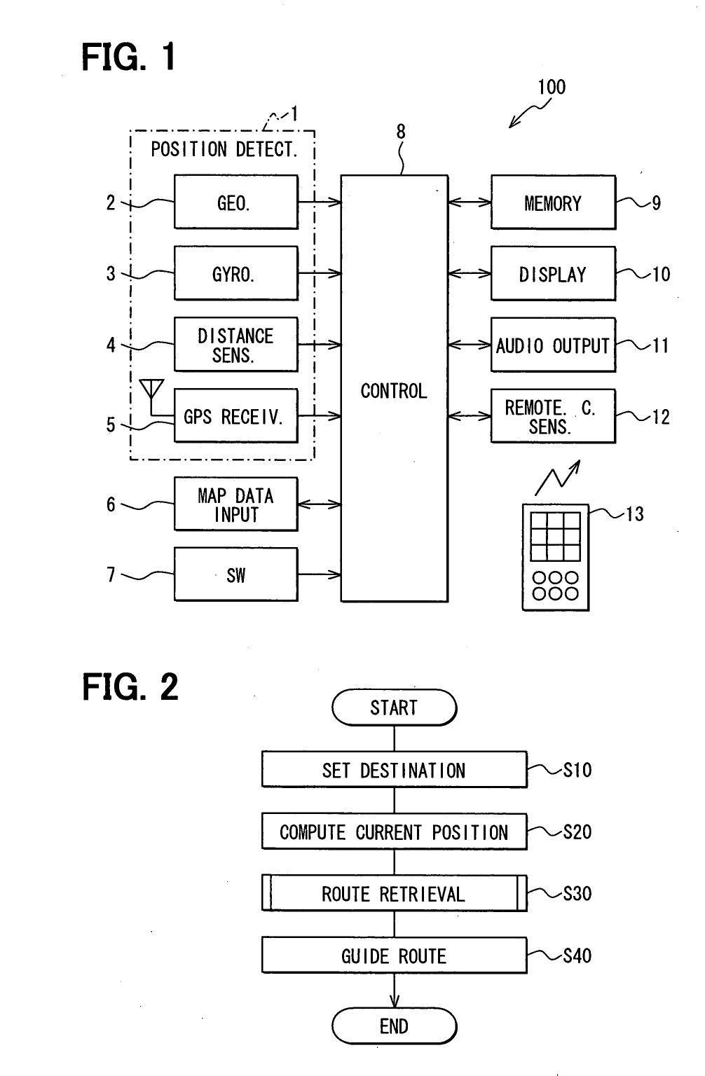

FIG. 1 is the block diagram showing the configuration of the in-vehicle navigation apparatus 100 in this embodiment. The in-vehicle navigation apparatus 100 includes a position detection unit 1, a map data input unit 6, an operation switch group 7, an external memory 9, a display unit 10, an audio output device 11, a remote control sensor 12, a control circuit 8 linked to the foregoing, etc.

The control circuit 8 is a usual computer to include a well-known CPU, ROM, RAM, I/O, and a bus line which connects the foregoing. The program for the control circuit 8 to perform is written in the ROM. The CPU etc. performs various data processing according to the program. In addition, the program is also acquirable from an outside through the external memory 9.

The navigation apparatus 100 as the route retrieval apparatus mentioned above includes a route retrieval program mainly executed by the control circuit 8. The control circuit 8 executes the route retrieval program when a destination is inputted by the control operation switch group 7. Usually, a current position is set to a departure point. The guide route from this departure point to a destination is retrieved (i.e., routing is performed) using the road map data read from the map data input unit 6. Thus, the control circuit 8 may function as a routing device.

The position detection unit 1 has well known sensors or the like such as a geomagnetic sensor 2, a gyroscope 3, a distance sensor 4, and a GPS receiver 5 for GPS (Global Positioning System) to detect a current position of the vehicle based on electric waves from satellites. The sensors or the like have different types of detection errors; therefore, these are used to complement each other. In addition, the position detection unit 1 may include part of the above sensors or the like depending on the required detection accuracy. Alternatively, the position detection unit 1 can include another sensor such as a steering rotation sensor and a speed sensor of each following wheel (none shown). Detecting the current position and traveling direction of the vehicle with this position detection unit 1 enables the control circuit 8 to perform routing and route guide which guides the vehicle according to the guide route.

The map data input unit 6 is used for inputting, to the control circuit 8, various kinds of map data containing road map data, background data, landmark data, etc. A storage medium to store the map data may be a read-only storage medium such as a CD-ROM or DVD-ROM, or a rewritable storage medium such as a memory card or a hard disk. Thus, the storage medium may function as a map data storage device.

The background data include geographical features and coordinates on map of facilities in association with each other. In addition, telephone numbers and addresses of the facilities are also stored. Moreover, character data are used to display names of places, facilities, roads, etc. on a map and stored in association with coordinate data corresponding to positions which should be displayed.

Here, the road map data are explained. The road map data include link data and node data. The node which indicates an intersection, a branch point, a juncture, etc. divides each road on map into multiple links; namely, a link is defined as being between two nodes. Link data include, with respect to each link, a unique number (link ID) for identifying the link, a link length, coordinates (latitude and longitude) of starting and ending nodes, a road name, a road class, a road width, the number of lanes, presence/absence of a dedicated lane for right or left turn, the number of the dedicated lanes, a speed limit, etc. In addition, when a node is contained in the middle of the link, the node coordinate data is also included in the link data.

Furthermore, node data include, with respect to each node, node coordinates, a node name, connection link IDs connected with the node, an intersection kind, etc.

The road map data are used in addition to display of maps, in the guide route retrieval to retrieve a route to a destination, and in the map matching to provide road shapes. Here, to retrieve a guide route, a road network data may be used. The road network data indicate connection relations of roads.

The operation switch group 7 includes mechanical switches or touch switches, which are integrated into the display unit 10 mentioned later, for example. The operation switch group 7 is used for various inputs, such as setting of departure points or destinations in the route retrieval.

The display unit 10 is, for example, composed of a liquid crystal display. The display unit 10 can display a vehicle position mark corresponding to a current position of the vehicle detected by the position detection unit 1, and a road map surrounding the vehicle and generated from the road map data, background data, landmark data, etc. which are inputted from the map data input unit 6. Moreover, it is also possible to change and display the road map in a predetermined scale or to scroll and display the road map, via the operation switch group 7 or remote control 13. Furthermore, in this embodiment, when a departure point and a destination are inputted from the operation switch group 7 or remote control 13, a guide route from the departure point to the destination can be retrieved (i.e., the routing can be performed) using the above-mentioned road map data. The retrieved guide route is then displayed.

The audio output device 11 is constructed of a speaker to report a variety of information such as audio assist performed in route guide. The remote control 13 is a multifunctional remote control equipped with various functions, for example, and directs the start and end of various navigation operation to the in-vehicle navigation apparatus 100 through the remote control sensor 12. In addition, the operation switch group 7 may perform these directions similarly.

Next, the guide route retrieval process and the route guide process according to the embodiment are explained using a flow chart of FIG. 2. First, at Step S10, a destination is inputted using the operation switch group 7 for retrieving a guide route. Next, at Step S20, a current position of the vehicle is computed based on detection signals from the position detection unit 1. The current position is used as a departure point. However, at Step S10, when a departure point is also inputted in addition to the destination, Step S20 is omitted.

At Step S30, retrieval process is performed for the guide route from the departure point to the destination. The route retrieval program for performing this retrieval process is prepared beforehand. When the control circuit 8 starts the route retrieval program, the guide route retrieval process is started. The details of this guide route retrieval process are mentioned later.

At Step S40, the retrieved guide route is displayed on the display unit 10. Based on the user's instruction, route guide is started. In this route guide process, the guide route is displayed on the road map in superimposition. When the vehicle approaches a guided intersection at which a right or left turn should be carried out, the direction of the turn is indicated by voice and/or the enlargement of the guided intersection is displayed on the display unit 10.

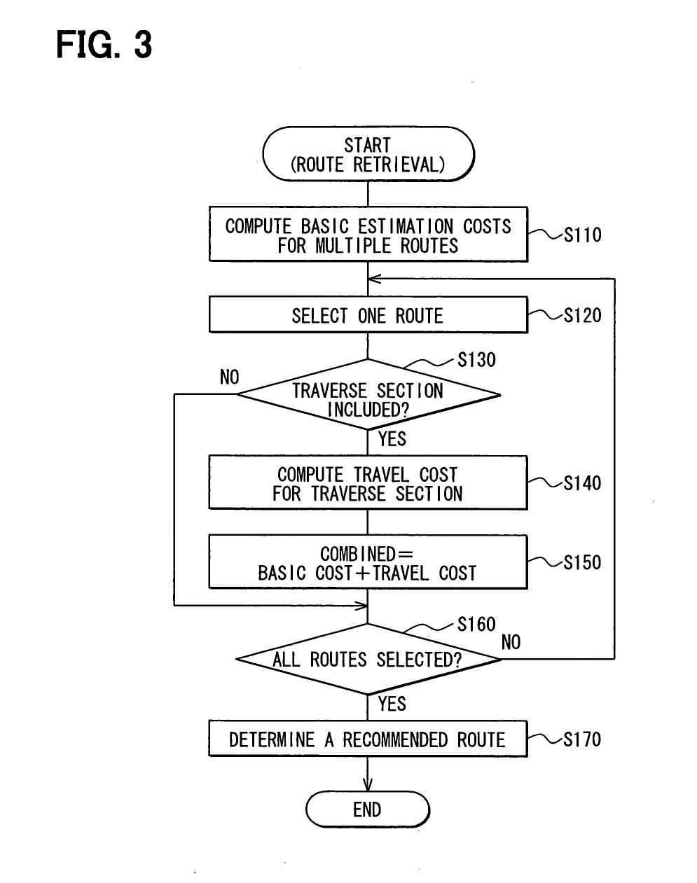

Next, the guide route retrieval process is explained based on the flow chart of FIG. 3. First, at Step S110, while retrieving multiple routes of reaching the destination from the departure point, for example, using the route retrieval technique such as the well-known Dijkstra method, basic estimation costs of the multiple routes are computed. The calculation method of this basic estimation cost is explained briefly below.

When retrieving the guide route from the departure point to the destination, a passing cost which indicates the ease of passing is computed for every link and node using the road map data. This passing cost is computed based on properties (link length, road class, width of road, etc.) of each link, and properties (going straight/right or left turn, traffic regulation, etc.) of each node. A condition (distance, time, general road, toll road, etc.) to which priority should be given in guide route retrieval may be specified by the user. In this case, according to the specified condition, the passing costs computed for every link and node may change so that a totaled value of the passing costs of the corresponding route becomes relatively small. The basic estimation cost of each of multiple routes to reach the destination from the departure point is calculated from a totaled value of passing costs of the nodes and links constituting each route. Thus, Step S110 performed by the control circuit 8 may function as a basic cost computing means or unit which computes a basic estimation cost, which is total of costs assigned in a predetermined rule to links and nodes included in a route.

At Step S120, a certain route is selected from multiple routes retrieved at Step S110. At Step S130, it is determined whether the selected certain route contains a predetermined route section (i.e., an entering and exiting route section or a traverse route section), in which the vehicle is to traverse a road or route section. In other words, the vehicle is to enter one side of a road, run not more than a predetermined travel distance, and exit to another road from the other side of the road, which is opposite to the entered side. The predetermined travel distance is set based on a maximum value of a reference travel distance. When this determination at Step S130 is affirmed, the process goes to Step S140. When negated, the process goes to Step S160. Thus, Step S130 performed by the control circuit 8 may function as a predetermined route section determination means or unit which determines a predetermined route section or road included in the retrieved route, wherein the vehicle is guided to enter one side of the predetermined route section and exit from the other side after running for a predetermined travel distance.

At Step S140, a travel estimation cost to the travel in the traverse route section is computed.

For example, a vehicle exits from an expressway and enters or joins a certain road at a joint point. In this case, if the number of lanes of the joined certain road is small, the driver of the vehicle can perform right or left turn comparatively easily to exit to another road via an intersection, which is in the short distance from the joint point. However, if the number of lanes of the joined certain road is large and, further, the vehicle needs to exit from the lane on the side opposite to the side of the entered lane, the vehicle or driver needs to repeatedly change lanes. For this reason, if the guide route is set such that the travel distance in the certain road up to the exit point (i.e., intersection) is too short, it is difficult for the driver to follow the guide route.

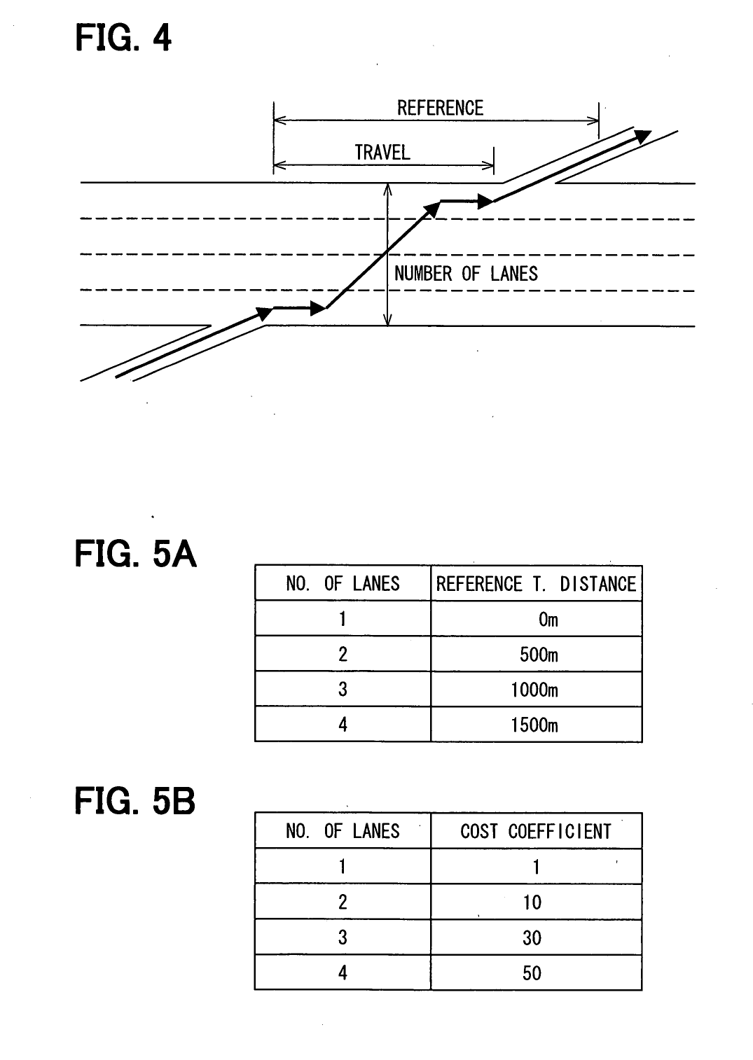

At Step S140, the travel estimation cost according to the difficulty of the travel in the traverse route section is computed based on the distance the vehicle runs the certain road (hereinafter referred to as a traversed road) corresponding to the traverse route section and the number of lanes of the traversed road. An example of the calculation method of this travel estimation cost is explained based on FIGS. 4, 5A, 5B.

First, as indicated in FIG. 4, the travel distance of the traversed road is obtained. The travel distance of this traversed road can be a distance from a joint point to an exit point. Furthermore, the vehicle may need to run an exit lane before exiting from the traversed road. In this case, the travel distance of the traversed road can be obtained by subtracting the distance for which the vehicle travels on the exit lane from the distance between the joint point and the exit point.

Next, the reference travel distance and cost coefficient are determined from the number of lanes of the traversed road. Beforehand, the reference travel distance and the cost coefficient are stored for every number of lanes as indicated in FIGS. 5A, 5B, respectively. Therefore, if the number of lanes of the traversed road can be obtained from the link data of the road map data, the reference travel distance and cost coefficient according to the number of lanes can be determined.

Here, the reference travel distance is defined from the aspect that lanes can be changed without the driver of the vehicle feeling the difficulty. As the number of lanes increases, the required number of lane changes increases; therefore, the distance which causes the driver to feel the difficulty for the lane changes becomes longer. Thus, as indicated in FIG. 5A, the reference travel distance is set up to be longer as the number of lanes increases. Similarly, as indicated in FIG. 5 (b), the cost coefficient is set up to be larger as the number of lanes increases.

The travel estimation cost to the travel on the traverse route section or the traversed road is computed using these reference travel distances, the travel distance of the traversed road, and the cost coefficient according to the following Formula 1.

Travel estimation cost=(Reference travel distance−Travel distance on traversed road)×cost coefficient. (Formula 1)

The travel distance on a traversed road may be below the reference travel distance. In this case, the travel estimation cost is computed to become larger as the travel distance becomes shorter than the reference travel distance. Moreover, the reference travel distance becomes longer as the number of lanes increases. For this reason, in the case where the number of lanes is increased, even if the travel distance on the traversed road is comparatively long, the travel estimation cost is computed to be large. Furthermore, the cost coefficient becomes larger as the number of lanes increases. Therefore, the travel estimation cost is computed to be large even when the difference between the reference travel distance and the travel distance on the traversed road is small in the case that the number of lanes is large. As a result, the travel estimation cost can correspond to the difficulty which the driver of the vehicle feels while traversing a road from when entering the road to when exiting from the road.

For instance, a road having a single lane in one traffic direction may correspond to the entering and exiting route section or traverse route section. In this case, even when the vehicle enters the single lane from one side and leaves the same lane from the other side, the vehicle is not necessary to change lanes. For this reason, when the traverse route section or traversed road has only a single lane in one traffic direction, the difficulty may not be felt for the driver to run the traversed road. Therefore, as indicated in FIG. 5A, the reference travel distance is set as 0 m. In this case, although the travel estimation cost is computed as a minus value, all minus values are converted into zero. In addition, when the traversed road has only a single lane in one traffic direction, the corresponding cost coefficient can be set as zero to make the travel estimation cost into zero.

Thus, Step S140 performed by the control circuit 8 may function as a predetermined cost computing means or unit which computes a predetermined estimation cost, which is larger as the vehicle is to run the traverse route section for a distance shorter than a reference travel distance.

Moreover, since the travel estimation cost is set as zero for the road having a single lane, computing of travel estimation cost is unnecessary and the calculation process may be omitted. Furthermore, at Step S130, it may be determined whether the traverse route section includes multiple lanes in one traffic direction. In this case, Step S130 performed by the control circuit 8 may function as a predetermined traverse determination means or unit which determines a multiple lane road having a plurality of lanes in the retrieved route. Further, when only one lane is included in the traverse route section or traversed road, Steps S140, S150 can be omitted.

At Step S150, a final estimation cost of the route is computed by combining the basic estimation cost computed at Step S110 and the travel estimation cost computed at Step S140. Thus, the estimation cost of the route can be computed while considering the difficulty in the travel accompanied by the lane changes in addition to the distance and/or the travel time of the route.

At Step S160, it is determined whether all the multiple routes, of which basic estimation costs were computed at Step S110, are selected at Step S120. When all the routes are determined to be not selected at Step S160, the process returns to Step S120. When all the routes are determined to be selected, the process goes to Step S170.

At Step S170, the route with the minimum estimation cost is designated as the recommended route and shown in the display unit 10. That is, the route which has the minimum estimation cost is chosen based on the basic estimation cost computed at Step S110, and the estimation cost computed at Step S150. Here, a route may has the travel estimation cost, which is computed as zero or is not computed. In this case, the basic estimation cost turns into the final estimation cost of the route.

Thus, by retrieving a route having the minimum estimation cost, the optimal route can be chosen while considering, in addition to the distance and the travel time of the route, the difficulty of the travel while entering and exiting from the traverse route section.

(Modifications)

For example, in the embodiment mentioned above, the travel estimation cost which indicates the difficulty in the travel of entering and exiting from the traverse route section is computed using above-mentioned Formula 1. However, the travel estimation cost can consider various calculation methods not using Formula 1 mentioned above. For example, a maximum cost, large cost, intermediate cost, and small cost may be beforehand assigned to corresponding travel distance ranges depending on the number of lanes. Thus, one of the four costs may be selected based on the travel distance on the traversed road. In this case, each value of the maximum cost, large cost, intermediate cost, and small cost is also changed according to the number of lanes.

For instance, with respect to four lanes, the travel distance range from 1500 m to 1300 m is given the small cost; from 1300 m to 1100 m, the intermediate cost; from 1100 m to 900 m, the large cost; and from 900 m to less than 900 m, the maximum cost. When the number of lanes is three or less, each travel distance range becomes short, compared with the four lanes. Furthermore, when the number of lanes is three or less, each value of the small cost, intermediate cost, large cost, and maximum cost is equivalent to or smaller than those for four lanes.

Similarly, in the above modification of the embodiment, the travel estimation cost for entering and exiting from a traverse route section or traversed road may increase as the number of lanes increases and/or the travel distance in the traverse route section decreases.

Moreover, in the embodiment mentioned above, multiple routes for reaching a destination from a departure point are retrieved first. Then, it is determined whether an entering and exiting route section or traverse route section is included in the retrieved routes. When the traverse route section is included, a travel estimation cost is thereby computed. In contrast, while the route from the departure point to the destination is retrieved with the route retrieval technique, such as the Dijkstra method, it may be determined whether there is a route section corresponding to the traverse route section. When the traverse route section is present, the travel estimation cost for entering and exiting from the traverse route section may be computed. Combined value of the passing cost given to the link and the node and the travel estimation cost may be the estimation cost for each route in the middle of the retrieval. The route having the smallest estimation cost in the middle of the retrieval is prioritized. Then, retrieving its remaining route to reach the destination is advanced. This can search for the route with the minimum estimation cost more quickly.

Each or any combination of processes, steps, or means explained in the above can be achieved as a software unit (e.g., subroutine) and/or a hardware unit (e.g., circuit or integrated circuit), including or not including a function of a related device; furthermore, the hardware unit can be constructed inside of a microcomputer. Furthermore, the software unit or any combinations of multiple software units can be included in a software program, which can be contained in a computer-readable storage media or can be downloaded and installed in a computer via a communications network.

Aspects of the subject matter described herein are set out in the following clauses.

As a first aspect, a route retrieval apparatus may be provided as follows. A map data storage device is included for storing road map data, in which a road is indicated by links and nodes, and a number of lanes of each link. A routing device is included for retrieving a route having a minimal estimation cost from a departure point to a destination based on links and nodes of the route by using the stored road map data. The routing device comprises a predetermined route section determination unit and a predetermined cost computing unit. The predetermined traverse determination unit determines a predetermined route section included in the retrieved route, wherein the vehicle is guided to enter one side of the predetermined route section and exit from a side opposite to the one side after running for a predetermined travel distance. The predetermined cost computing unit computes a predetermined estimation cost, which is larger as the predetermined travel distance is shorter than a reference travel distance, the reference travel distance being defined based on a number of lanes included in the predetermined route section. Here, the routing device retrieves the route having the minimal estimation cost while considering the computed predetermined estimation cost.

Thereby, an estimation cost can be computed to meet with the difficulty which the driver of the vehicle feels when changing lanes. A total estimation cost for the route including the predetermined route section (i.e., entering and exiting route section, traverse route section, or traversed road) can be obtained considering this computed estimation cost.

Furthermore, it is desirable that the predetermined estimation cost can be computed to be larger as the number of lanes of the predetermined route section is larger. For instance, a cost coefficient is set to be increased as the number of lanes increases.

Furthermore, it is desirable that the reference travel distance be set as being longer as the number of lanes increases. Since the number of required lane changes increases as the number of lanes increases, the distance required to perform the lane change smoothly is also extended.

Furthermore, when the travel distance on the predetermined route section exceeds the reference travel distance, the estimation cost for the travel on the predetermined route section (i.e., traverse route section) may be set as being zero. This is because the driver of the vehicle can change lanes, without feeling the difficulty.

Furthermore, the routing device may give cost to links and nodes which constitute a route according to a predetermined rule. A basic estimation cost of the route is computed by totaling the costs given to the links and the nodes. It is desirable to compute a final estimation cost of the route by adding the estimation cost for the travel on the predetermined route section to the basic estimation cost. Thereby, in addition to the travel distance and travel time of a route, the difficulty of the travel accompanied by the lane change within the route can be also comprehensively taken into consideration. The optimal route can be thereby selected.

As another aspect, a method is provided for retrieving a route for a vehicle. The method comprises the steps of: retrieving a route from a departure point to a destination based on links and nodes of the route by using road map data, in which a road is indicated by links and nodes; determining a predetermined route section included in the retrieved route, wherein the vehicle is guided to enter one side of the predetermined route section and exit from a side opposite to the one side after running for a predetermined travel distance; and computing a predetermined estimation cost, which is larger as the predetermined travel distance is shorter than a reference travel distance, the reference travel distance being defined based on a number of lanes included in the predetermined route section, wherein the route having a minimal estimation cost is retrieved with the computed predetermined estimation cost considered.

It will be obvious to those skilled in the art that various changes may be made in the above-described embodiments of the present invention. However, the scope of the present invention should be determined by the following claims.

What is claimed is:

1. A route retrieval apparatus for a vehicle, the apparatus including:
a map data storage device which stores road map data, in which a road is indicated by links and nodes, and a number of lanes of each link; and
a routing device which retrieves a route having a minimal estimation cost from a departure point to a destination based on links and nodes of the route by using the stored road map data, wherein
the routing device comprising:
a predetermined route section determination unit which determines a predetermined route section included in the retrieved route, wherein the vehicle is guided to enter one side of the predetermined route section and exit from a side opposite to the one side after running for a predetermined travel distance; and
a predetermined cost computing unit which computes a predetermined estimation cost, which is larger as the predetermined travel distance is shorter than a reference travel distance, the reference travel distance being defined based on a number of lanes included in the predetermined route section,
wherein the routing device retrieves the route having the minimal estimation cost while considering the computed predetermined estimation cost.

2. The route retrieval apparatus of claim 1, wherein
the predetermined cost computing unit computes the predetermined estimation cost, which is larger as the number of lanes of the predetermined route section is larger.

3. The route retrieval apparatus of claim 1, wherein
the reference travel distance is defined as being longer as the number of lanes of the predetermined route section is larger.

4. The route retrieval apparatus of claim 1, wherein
the predetermined cost computing unit estimates as zero a predetermined estimation cost for travel on the predetermined route section when the travel distance exceeds the reference travel distance.

5. The route retrieval apparatus of claim 1, wherein
the routing device further includes a basic cost computing unit, which computes a basic estimation cost, which is total of costs assigned in a predetermined rule to links and nodes included in the route, wherein the routing device retrieves the route based on a combination of the computed basic estimation cost and the computed predetermined estimation cost.

6. A method for retrieving a route for a vehicle, the method comprising:
retrieving a route from a departure point to a destination based on links and nodes of the route by using road map data, in which a road is indicated by links and nodes;
determining a predetermined route section included in the retrieved route, wherein the vehicle is guided to enter one side of the predetermined route section and exit from a side opposite to the one side after running for a predetermined travel distance; and
computing a predetermined estimation cost, which is larger as the predetermined travel distance is shorter than a reference travel distance, the reference travel distance being defined based on a number of lanes included in the predetermined route section,
wherein the route having a minimal estimation cost is retrieved with the computed predetermined estimation cost considered.
